(19) United States
(12) Patent Application Publication
(10) Pub. No.: US 2023/0162058 A1
(43) Pub. Date: May 25, 2023

(54) SYSTEMS AND METHODS FOR IMPLEMENTING PLAYBOOKS

(71) Applicant: SuccessKPI, Inc, Centreville, VA (US)

(72) Inventors: Praphul KUMAR, Aldie, VA (US); David J. RENNYSON, Centreville, VA (US); Piyush PATEL, South Riding, VA (US); Pawel KRAWCZYK, Warsaw (PL)

(73) Assignee: SuccessKPI, Inc, Centreville, VA (US)

(21) Appl. No.: 17/535,323

(22) Filed: Nov. 24, 2021

(51) Int. Cl. G06N 5/04

(52) U.S. Cl. CPC G06N 5/04

(57) ABSTRACT

Methods and systems are disclosed herein for using machine learning models to identify insights and themes in communications of an enterprise and assign incoming communications to each theme or insight. One mechanism for identifying insights and themes in communications of an enterprise involves using two different machine learning models. The first machine learning model may identify characterizations (e.g., topics) associated with communications received by the enterprise and provides the different characterizations to a user. The system then receives groupings of those characterization to generate one or more playbooks to be used by the enterprise. The playbooks may be updated with scoring strategies and actions to aid the enterprise with addressing the themes and insights.

### BACKGROUND

In recent years many enterprises have been communicating with users over various channels including electronic mail, instant messages, voice (e.g., customer support), and video. All these disparate communications methods may have great insights and themes that may be useful to a particular enterprise. However, it is difficult to collect and process all that information, at least, because the process is very resource and time intensive. Recently, use of machine learning technologies has been growing exponentially. Machine learning models are now used in many technology areas including computer vision, network monitoring, autonomous driving, and others. Generally, machine learning models are trained using, for example, a training dataset and then used to make predictions based on that training.

### SUMMARY

Accordingly, methods and systems are disclosed herein for using machine learning models to identify insights and themes (e.g., topics) in communications of an enterprise and assign incoming communications to each theme or insight. One mechanism for identifying insights and themes in communications of an enterprise involves using two different machine learning models. The first machine learning model may identify characterizations (e.g., topics) associated with communications received by the enterprise and provides the different characterizations to a user. The system then receives groupings of those characterization to generate one or more playbooks to be used by the enterprise. The playbooks may be updated with scoring strategies and actions to aid the enterprise with addressing the themes and insights. A communication processing system may be used to perform operations for identifying insights and themes in communications of an enterprise and assigning incoming communications to each theme or insight.

In some embodiments, to identify insights and themes in communications with an enterprise, the communication processing system may receive a plurality of electronic communications that includes user interactions with the enterprise. Those communications may include electronic mail (e-mail) communications, audio communications (e.g., customer support calls), instant messaging communications (e.g., Short Message Service (SMS) communications) and/or other suitable communications.

The communication processing system may input each of the plurality of electronic communications into a first machine learning model to obtain a plurality of characterizations (e.g., a plurality of topics) associated with the plurality of electronic communications. The first machine learning model may be a model that has been trained to output one or more characterizations responsive to an input of electronic communication data. For example, the electronic communications for an enterprise may include thousands of communications. The communication processing system may transform the communications into a single format (e.g., a textual format) in some instances with associated metadata (e.g., for customer support calls, call duration, silence duration with the call, duration of two voice speaking over each other, etc.) and input that information into the first machine learning model. The first machine learning model may output a plurality of characterizations of the electronic communications (e.g., topics, themes, etc.). The output may be based on training the machine learning model using a training data that included characterizations and associated text/metadata labelled with a characterization name.

When the first machine learning model outputs the different characterizations, the communication processing system may enable a user to generate one or more playbooks based on the characterizations. That is, the user is enabled to select different/groups of characterizations to be included in the playbook. Thus, the communication processing system may receive, from an input device, a plurality of groupings for the plurality of characterizations. Each grouping of the plurality of groupings may correspond to a playbook.

The communication processing system may then generate a plurality of playbooks based on the plurality of groupings. That is, the communication processing system may store in, for example, each playbook definition the corresponding groupings received from an input device. One example, of a playbook may be a target of improving response to technical incidents. The creation of that playbook may be caused by a variety of communications where users may have been having issues. In particular, there may be a number of technical support calls and email communications with indications that a battery of an electronic device loses charge very quickly. Based, on those electronic communications, the communication processing system may, via the first machine learning model, determine that there is an issue with the electronic device and enable a user to generate a playbook for that issue.

In some embodiments, the communication processing system may enable a user to generate a scoring strategy for each playbook. For example, when a future communication matches with a playbook, the scoring strategy may enable different actions to be performed based on the scoring. In instances where the score matches a first threshold a first action may be performed. When the score matches a second threshold a different action may be performed. To continue with the example above, if the playbook is generated dealing with issues of electronic devices, the first action may be to direct a user to a troubleshooting page where the user is able to follow the process to replace the electronic device. The second action (e.g., in response to a user being very irritated) may be to give the user an electronic device for user while the user's device is being repaired.

When the playbooks have been generated those playbooks may be used on electronic communications. Thus, the communication processing system may receive an electronic communication that includes a user interaction. The communication may be an email exchange, a technical support call transcript, or another suitable communication exchange.

The communication processing system may input the electronic communication into the first machine learning model to obtain a set of characterizations associated with the electronic communication. For example, if the electronic communication is a technical support call, the first machine learning model may output a number of characterizations associated with that technical support call. Those characterizations may include electronic device issue, technical support, and other suitable characterizations.

The communication processing system may compare, the set of characterizations to characterizations within each of the plurality of playbooks and select, based on the comparing, a matching playbook of the plurality of playbooks. In some embodiments, the communication processing system may select multiple playbooks based on the set of characterizations. For example, the enterprise may include a number of playbooks including “technical support improvement,” “device troubleshooting improvement,” and/or other playbooks. Each of those playbooks may include associated characterizations. Thus, the communication processing system may match the electronic communication with one or more playbooks using the characterizations. For example, if the electronic communication is a technical support call for an electronic device, the communication processing system may match the electronic communication with both “technical support improvement” and “device troubleshooting improvement” playbooks. It should be noted that the playbook may be matched with an electronic communication even if not all characterizations match. For example, the communication processing system may indicate a match when only one characterization matches between the playbook and the electronic communication.

Thus, the communication processing system may generate a matching set of characterizations such that the matching set of characterizations includes those characterizations within the plurality of characterizations that match the characterizations within the matching playbook. For example, a particular electronic communication may be associated with five different characterizations, but a matching playbook may be associated with only three characterizations. Accordingly, the communication processing system may generate a set of characterizations including the three characterizations while excluding the other two characterizations from the set.

When the matching characterization set has been determined, the communication processing system may execute the scoring strategy portion of the playbook. Thus, the communication processing system may determine, within the matching set of characterizations, a subset of characterizations that includes characterizations having a plurality of associated characterization parameters. In some embodiments the matching set of characterizations may include characterizations with parameters and characterizations that do not include parameters. Those characterizations that do not include parameters may be associated with particular assigned scores when the playbook is created. For example, for a technical support call if it has been detected that there was an automatic call back, that characterization may be associated with a particular score. However, if the characterization is that there is silence (i.e., dead air) on the call, that characterization may have parameters (e.g., duration, a count of silences, whether silence was expected, etc.). Those characterizations that include characterization parameters may be processed differently.

Thus, the communication processing system may input each of the plurality of associated characterization parameters into a second machine learning model to generate a corresponding score for each characterization in the subset of characterizations. The second machine learning model may be trained to generate scores based on characterization parameters. The second machine learning model may output for each parameter a score. Thus, both types of characterizations may be associated with corresponding scores. The communication processing system may generate an aggregate score for the electronic communication as determined for the particular playbook. Thus, the communication processing system may determine, based on each corresponding score, an action of a plurality of actions. For example, if a combined score is below a first threshold, a first action is performed (e.g., a recommendation of a webpage). If a combined score is above the first threshold, a second action is performed (e.g., expedited processing of the issue may be performed).

Various other aspects, features and advantages of the system will be apparent through the detailed description and the drawings attached hereto. It is also to be understood that both the foregoing general description and the following detailed description are examples, and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a part of, or the entirety of (i.e., the entire portion), a given item (e.g., data), unless the context clearly dictates otherwise.

### BRIEF DESCRIPTION OF THE DRAWINGS

FIG. 1 illustrates a system for identifying insights and themes in communications, in accordance with one or more embodiments of this disclosure.

FIG. 2 illustrates a plurality of electronic communication types and types of associated electronic parameters, in accordance with one or more embodiments of this disclosure.

FIG. 3 illustrates a set of generated electronic parameters for an electronic communication, in accordance with one or more embodiments of this disclosure.

FIG. 4 illustrates an exemplary machine learning model, in accordance with some embodiments of this disclosure.

FIG. 5 illustrates an exemplary interface for configuring characterizations for a playbook, in accordance with one or more embodiments of this disclosure.

FIG. 6 illustrates an exemplary interface for configuring a strategy for a playbook, in accordance with one or more embodiments of this disclosure.

FIG. 7 illustrates an exemplary interface for configuring an action for a playbook, in accordance with one or more embodiments of this disclosure.

FIG. 8 shows an example computing system that may be used, in accordance with one or more embodiments of this disclosure.

FIG. 9 is a flowchart of operations for a mechanism for identifying insights and themes in an electronic communication, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

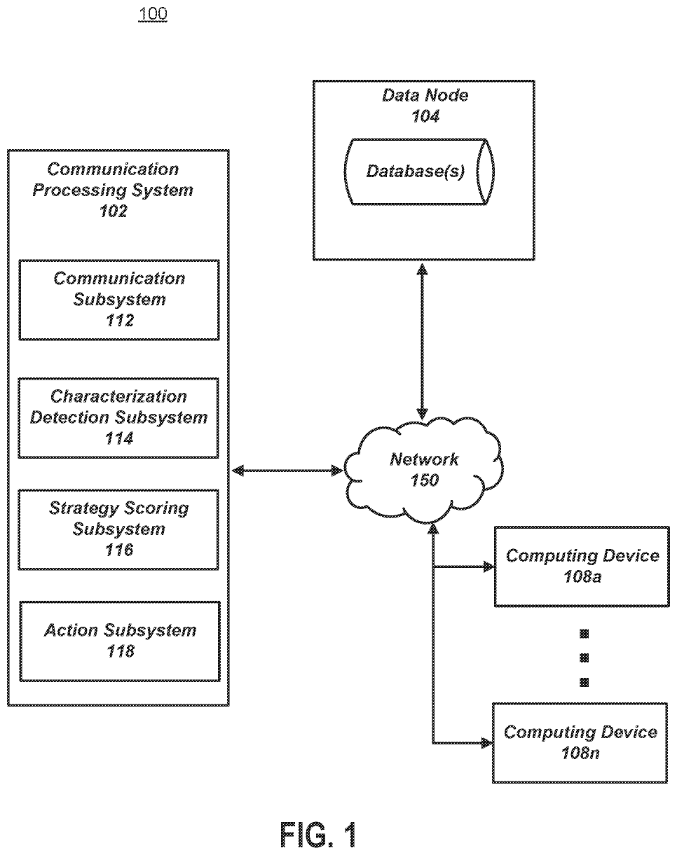

FIG. 1 illustrates environment 100, which includes a system for using machine learning models to identify insights and themes in communications. Environment 100 includes communication processing system 102, data node 104, and computing devices 108a-108n. Communication processing system 102 may execute instructions for using machine learning models to identify insights and themes in communications, and may include software, hardware or a combination of the two. For example, communication processing system 102 may be a physical server or a virtual server that is running on a physical computer system.

Data node 104 may store various data, including various machine learning models, training and other datasets, and other data required by the communication processing system. In some embodiments, data node 104 may store the first machine learning model and the second machine learning model. In some embodiments, data node 104 may also be used to train the machine learning models. Data node 104 may include software, hardware, or a combination of the two. For example, data node 104 may be a physical server, or a virtual server that is running on a physical computer system. Network 150 may be a local area network, a wide area network (e.g., the Internet), or a combination of the two. Computing devices 108a-108n may be end-user computing devices (e.g., desktop computers, laptops, electronic tablets and/or other computing devices used by end users). Computing devices 108a-108n may be used to output data to a use and receive user input.

Communication processing system 102 may include communication subsystem 112. Communication subsystem 112 may include software components, hardware components, or a combination of both. For example, communication subsystem 112 may include a network card (e.g., a wireless network card and/or a wired network card) that is coupled with software to drive the card. Communication processing system 102 may also include characterization detection subsystem 114. Characterization detection subsystem 114 may include software components, hardware components, or a combination of both. Characterization detection subsystem 114 may perform characterization detection for both building playbooks and executing playbooks on incoming electronic communications.

In addition, communication processing system 102 may include strategy scoring subsystem 116. Strategy scoring subsystem 116 may include software components, hardware components, or a combination of both. Strategy scoring subsystem 116 may perform various functions for scoring characterizations for different playbooks. Communication processing system 102 may also include action subsystem 118. Action subsystem 118 may include software components, hardware components, or a combination of both. In some embodiments, action subsystem 118 may perform actions determined as a result of scoring particular characterizations. For example, action subsystem 118 may transmit electronic message including webpage links to computing devices 108a-108n.

One mechanism for identifying insights and themes in an electronic communication is to use a multi-model machine learning approach. Communication processing system 102 may receive, using communication subsystem 112 an electronic communication that includes a user interaction. The electronic communication may be in a form of a data file. The data file may include textual data and/or metadata. For example, the textual data may be a transcript of an instant messaging exchange between a user and a support agent. The textual data may include timing information indicating when each statement within the transcript was sent. In some embodiments, the data file may be an audio recording of a conversation between the support agent and a user. The audio recording may be converted into textual transcript with metadata. The metadata may include timing information of each statement within the transcript, sentiment data, silence data (e.g., the times within the recording where no one spoke), and/or talk over data (e.g., the times when two or more participants are talking at the same time). In some embodiments, the electronic communication may be an exchange of email between technical support and a user. Communication subsystem 112 may pass the electronic communication to characterization detection subsystem 114.

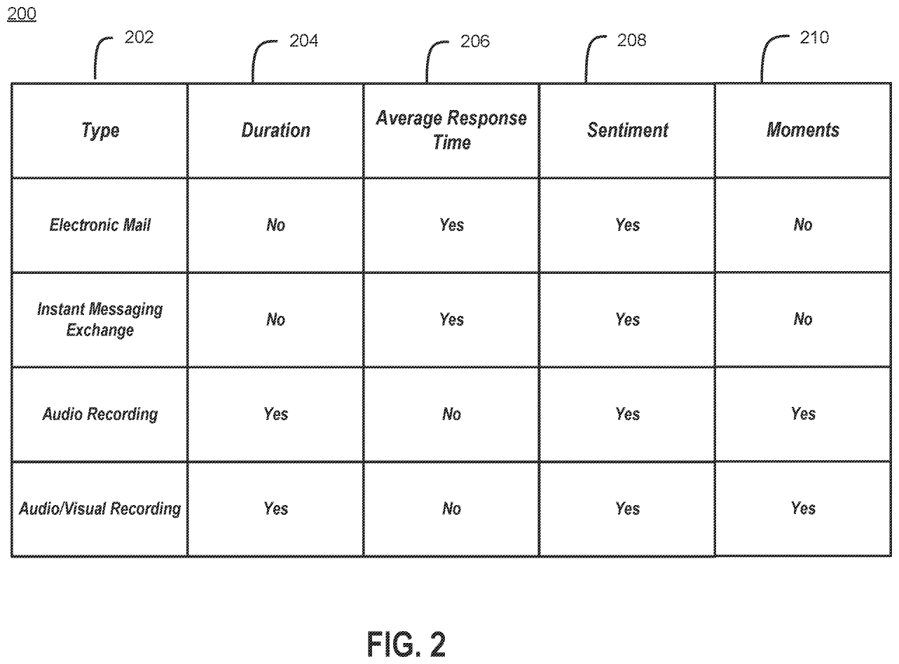

In some embodiments, characterization detection subsystem 114 may receive an electronic file without any pre-processing. For example, the electronic file may be an email exchange, an instant messaging conversation, or an audio file including audio data for a technical support call. Characterization detection system may determine a type associated with the electronic communication and generate a transcription of the electronic communication. FIG. 2 illustrates a table 200 including a plurality of electronic communication types and types of associated electronic parameters. Column 202 illustrates a communication type. Although four electronic communication types are illustrated in column 202, more or less electronic communication types may be available for the system. Thus, characterization detection system may determine the type of the electronic communication. Based on the type of electronic communication, characterization detection subsystem 114 may generate electronic communication parameters for the communication.

Column 204 illustrates the duration electronic parameter and whether it should be generated for different types of electronic communications. For example, the duration parameter should not be generated for an electronic mail because electronic mail can be sent and received over long time periods (e.g., hours, days, etc.), thus this electronic communication parameter is not helpful in this context. Conversely, for an audio recording and an audio/visual recording that parameter should be generated as a recording would have a duration. Column 206 illustrates an average response time electronic communication parameter (e.g., how long it takes to respond to a user request). That parameter may not be important in the context of an audio recording, because the conversation is near instantaneous. However, this parameter may be important in the context of an electronic mail.

Column 208 illustrates a sentiment parameter (e.g., content, irate, happy, sad, angry, etc.) and column 210 illustrates a moment electronic parameter. For example, the moment parameter may indicate whether there was silence in the audio and, in some embodiments, that electronic parameter may indicate the quality of the silence. That is, was silence detected because the technical support agent asked the user to wait for a bit to retrieve some information or may be silence was there because the technical support agent did not know how to response. Thus, characterization detection subsystem 114 may generate a plurality of electronic communication parameters corresponding to the type associated with the electronic communication. As discussed above, in some embodiments, the plurality of electronic communication parameters comprises one or more of communication duration, communication sentiment, silence duration within the electronic communication, and simultaneous speech duration within the electronic communication.

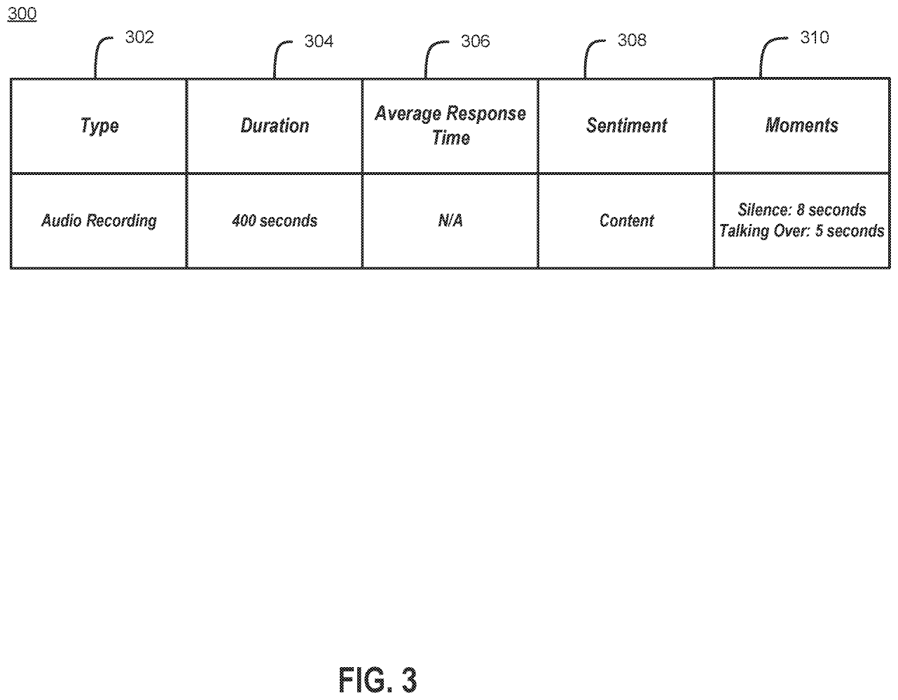

FIG. 3 illustrates an entry 300 that includes a set of generated electronic parameters for a particular electronic communication. Column 302 illustrates that the type of electronic communication is an audio recording. Column 304 indicates that the duration is four hundred seconds. Column 306 illustrates that the average response time has not been generated based on indications in FIG. 2. Column 308 illustrates a sentiment value and column 310 indicates that there have been two moments detected. One moment was silence for fifteen seconds and another moment was talking over for 5 seconds. It should be noted that the quality of each moment is not shown. However, silence may have an associated quality as discussed above. Talking over may also have an associated quality.

Characterization detection subsystem 114 may input the electronic communication (e.g., the textual transcript and the metadata) into a first machine learning model to obtain a plurality of characterizations associated with the electronic communication. The first machine learning model may be a model that has been trained to output one or more characterizations responsive to an input of electronic communication data. Each characterization may be associated with one or more words and/or phrases. Thus, the first machine learning model may have been trained using words and phrases and associate characterization labels. For example, the first machine learning model may have been trained using a training dataset. The training dataset may include a plurality of statements labelled with corresponding one or more characterizations. In some embodiments, each statement may be transformed into a vector before being input into the training algorithm of the first machine learning model. In some embodiments, the metadata may include the electronic communication parameters.

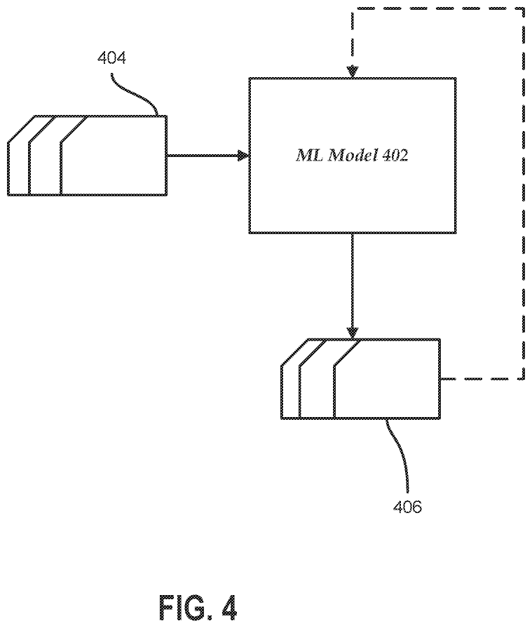

FIG. 4 illustrates an exemplary machine learning model, that may be used to identify characterizations associated with an electronic communication. Machine learning model 402 may take input 404 (e.g., a vector representation of textual data of the electronic communication and, in some embodiments, electronic communication parameters) and may generate output parameters 406 which may be one or more characterizations.

The output parameters 406 may be fed back to the machine learning model as input to train the machine learning model (e.g., alone or in conjunction with user indications of the accuracy of outputs, labels associated with the inputs, or with other reference feedback information). The machine learning model may update its configurations (e.g., weights, biases, or other parameters) based on the assessment of its prediction (e.g., of an information source), and reference feedback information (e.g., user indication of accuracy, reference labels, or other information). Connection weights may be adjusted, for example, if the machine learning model is a neural network, to reconcile differences between the neural network's prediction and the reference feedback. One or more neurons of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function which combines the values of all of its inputs together. Each connection (or the neural unit itself) may have a threshold function that a signal must surpass before it propagates to other neural units. The machine learning model may be self-learning and/or trained rather than explicitly programmed, and may perform significantly better in certain areas of problem solving, as compared to computer programs that do not use machine learning. During training, an output layer of the machine learning model may correspond to a classification of machine learning model, and an input known to correspond to that classification may be input into an input layer of the machine learning model during training. During testing, an input without a known classification may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector.

The machine learning model may be structured as a factorization machine model. The machine learning model may be a non-linear model and/or supervised learning model that can perform classification and/or regression. For example, the machine learning model may be a general-purpose supervised learning algorithm that the system uses for both classification and regression tasks. Alternatively, the machine learning model may include a Bayesian model configured to perform variational inference on the graph and/or vector.

When the characterizations are received from the machine learning model, characterization detection subsystem 114 may match the characterizations with one or more playbooks associated with the particular enterprise. Characterization detection system may compare the identified characterizations with characterizations associated with each playbook. If a match is found, characterization detection subsystem 114 may determine that the electronic communication matches with a particular playbook. In some embodiments, characterization detection subsystem 114 may determine a match if at least one characterization matches. However, in some embodiments, all or at least fifty percent of characterizations must match before characterization detection subsystem 114 determines that the electronic communication matches a playbook. Thus, characterization detection subsystem 114 may select, based on the plurality of characterizations, a matching playbook of a plurality of playbooks.

In some embodiments, characterization detection subsystem 114 may generate the plurality of playbooks for a particular enterprise. Characterization detection subsystem 114 may receive a plurality of electronic communications that include user interactions. For example, each communication may be an electronic file including textual data of the communication along with metadata. The files may be received from, for example, data node 104 via network 150. The files may be first received by communication subsystem 112 and passed to characterization detection subsystem 114. Characterization detection subsystem 114 may input each of the plurality of electronic communications into the first machine learning model to obtain the plurality of characterizations associated with the plurality of electronic communications. For example, each electronic communication may be input (e.g., with associated metadata) into the first machine learning model. This process may be similar to the process described above. As characterizations for each electronic communication are received by characterization detection subsystem 114, characterization detection subsystem may track which characterizations have been detected in the electronic communications.

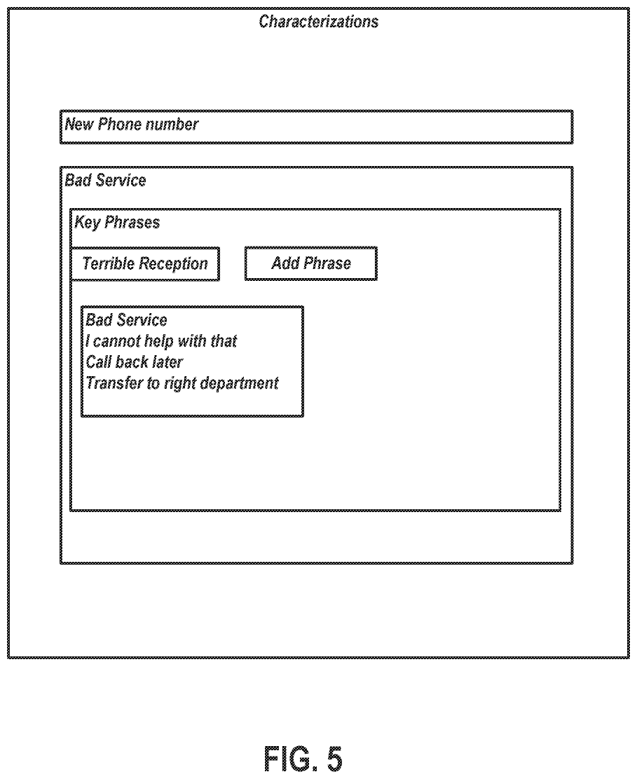

When all electronic communications have been processed, characterization detection subsystem 114 may provide a list of detected characterizations to the user for generating playbooks. FIG. 5 illustrates a graphical user interface that may be provided to a user device (e.g., one of computing devices 108a-108n). Characterization detection subsystem 114 may enable the user to select one or more characterizations and add those characterizations to a new playbook to be generated. Thus, characterization detection subsystem 114 may receive, from an input device, a plurality of groupings for the plurality of characterizations and generate the plurality of playbooks based on the plurality of groupings.

Thus, characterization detection subsystem 114 may perform a comparison of characterizations associated with the created playbooks and characterizations associated with the received electronic communication to determine which playbooks the electronic communication matches. When one or more matches are determined, characterization detection subsystem 114 may store an association between the electronic communication and the matching playbooks.

Characterization detection subsystem 114 may select each matching playbook in turn or in parallel and perform the following actions for each playbook. Characterization detection subsystem 114 may generate a first set of characterizations. The first set of characterizations may include characterizations within the plurality of characterizations that match the characterizations within the matching playbook. For example, the matching playbook may include five different characterizations while the electronic communication may include four different characterizations. Out of the four different characterizations only three may match the characterizations associated with the playbook. Thus, characterization detection subsystem 114 may select those three characterizations to be added to the first set of characterizations.

In some embodiments, characterization detection subsystem 114 may enable a user to add a new characterization to a particular playbook. Thus, characterization detection subsystem 114 may receive, from an input device, a plurality of phrases, for a new characterization. The plurality of phrases may be received with identification data (e.g., a name) to be associated with the new characterization. Characterization detection subsystem 114 may then train the first machine learning model using the plurality of phrases and the new characterization to recognize the new characterization as associated with the plurality of phrases. In some embodiments, characterization detection subsystem 114 may invoke a training routing associated with the first machine learning model to train the first machine learning model to recognize the new characterization.

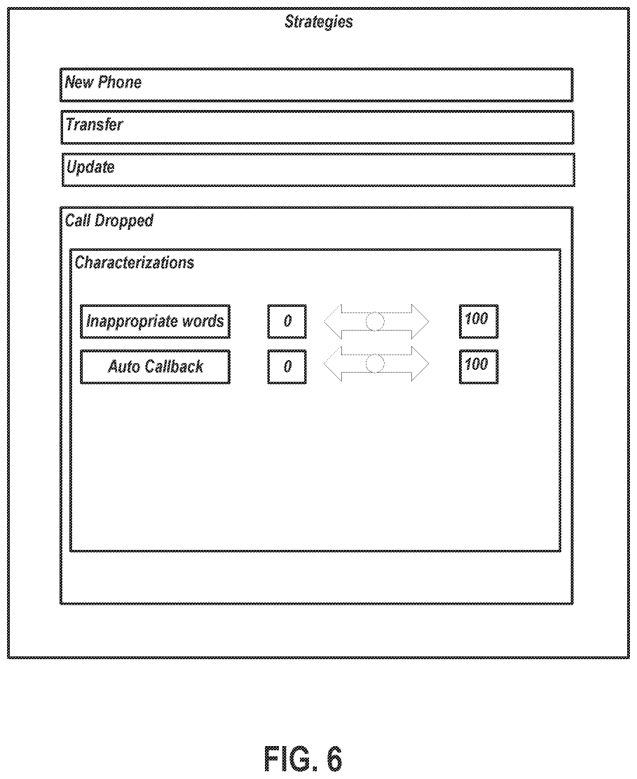

Characterization detection subsystem 114 may then pass the set of characterizations and the associated playbook data to strategy scoring subsystem 116. In some embodiments, the first set of characterizations may have characterizations of different types. For example, a first type of characterization may include characterization parameters and a second type of characterization parameters may not include characterization parameters. Thus, strategy scoring subsystem 116 may determine, within the first set of characterizations, a first subset of characterizations that includes those characterizations that do not have associated characterization parameters. For the first subset, strategy scoring subsystem 116 may perform a lookup of a score associated with each characterization that does not have any characterization parameters. FIG. 6 illustrates an interface within a playbook design system that may enable a user to set a score for each characterization that does not have associated characterization parameters.

In addition or in the alternative, strategy scoring subsystem 116 may determine, within the first set of characterizations, a subset of characterizations that includes those characterizations having a plurality of associated characterization parameters. In some embodiments, strategy scoring subsystem 116 may perform a lookup (e.g., in a database table or a structured file) to determine which characterizations are associated with characterization parameters and which are not. In some embodiments, strategy scoring subsystem 116 may access the data structure associated with the characterization itself. The data structure may be a structured filed such as an XML file or may be stored in a database. Strategy scoring subsystem 116 may determine based on accessing the data structure whether characterization parameters are included within the characterization data structure.

Strategy scoring subsystem 116 may then input each of the plurality of associated characterization parameters into a second machine learning model to generate a corresponding score for each characterization in the subset of characterizations. The second machine learning model may be a model that is trained to generate scores based on characterization parameters. For example, the second machine learning model may have been trained with sets of characterization parameters labelled with associated scores. Thus, strategy scoring subsystem 116 may receive, from the second machine learning model, a score for each characterization based on the associated characterization parameters.

Strategy scoring subsystem 116 may process various types of characterization parameters. For example, strategy scoring subsystem 116 may determine that a first characterization parameter of the subset of characterization parameters includes timing data. The time data may include the duration of time that there was silence in the audio file. In some embodiments, strategy scoring subsystem 116 may also determine the number and length of each silence. Strategy scoring subsystem 116 may then input, into the second machine learning model, the first characterization parameter (e.g., the timing data) and a parameter type associated with the timing data.

In some embodiments, a particular characterization may be accompanied by question answer data. That is, a plurality of questions may be answered (e.g., by a technical support agent) about the audio communication. Thus, strategy scoring subsystem 116 may determine that a first characterization parameter of the subset of characterization parameters includes question answer data and input, into the second machine learning model, the first characterization parameter and a parameter type associated with the question answer data. Strategy scoring subsystem 116 may then calculate a total score for the electronic communication based on the scores received from the second machine learning model and the scores looked up from the associated playbook. In some embodiments, the characterization parameters may include string data, as discussed above.

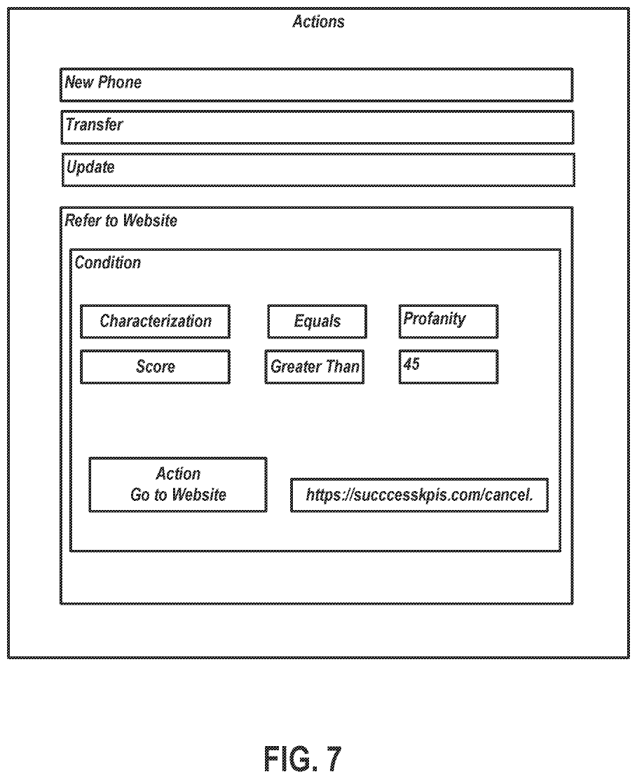

When strategy scoring subsystem 116 determines the total score, strategy scoring subsystem 116 may pass the total score to action subsystem 118. Action subsystem 118 may determine, based on each corresponding score, an action of a plurality of actions. For example, one action may point a user to a webpage enabling the user to cancel service. FIG. 7 illustrates an exemplary screen for configuring an action for a particular playbook. Another action may include generation of a dashboard. Other actions may be added to a particular playbook (e.g., send an email, send an SMS, escalate the issue, and/or another suitable action).

In some embodiments, communication processing system 102 may enable a user to create a playbook using, for example, graphical user interfaces illustrated in FIGS. 5-7. Communication processing system 102 may receive a request from a user to generate a playbook. Communication processing system 102 may provide to the user (e.g., at one of computing devices 108a-108n) a graphical user interface to generate a playbook. The user may be enabled to enter the name of the playbook. When the name has been entered, communication processing system 102 may generate for display a graphical user interface of FIG. 5 enabling the user to add characterizations to the playbook and create new characterizations to be added to the playbook. When the characterizations are completed, communication processing system 102 may generate for display a graphical user interface of FIG. 6 enabling the user to add scoring strategies to the playbook. When the scoring strategies are added, communication processing system 102 may generate for display FIG. 7 enabling the user to add actions to the playbook and then save the playbook.

### Computing Device Components

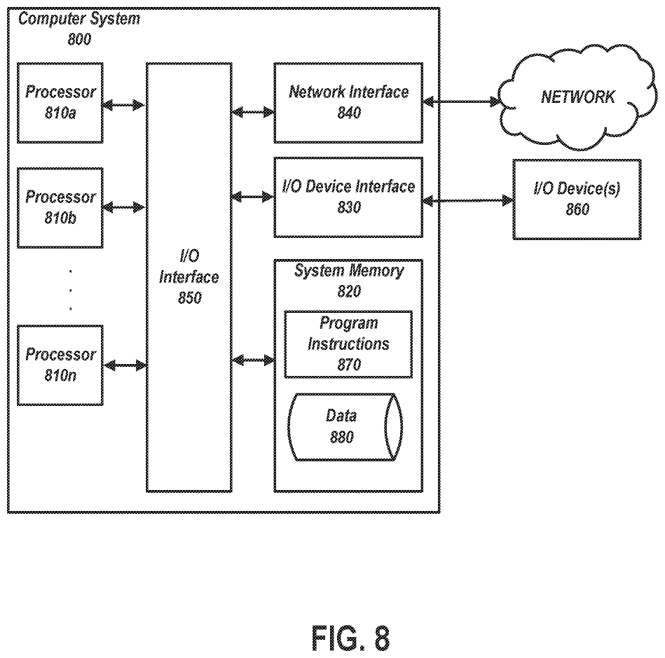

FIG. 8 shows an example computing system that may be used in accordance with some embodiments of this disclosure. Specifically, communication processing system 102, data node 104 and/or computing devices 108a-108n may use one or more of the components described below. In some instances, computing system 800 is referred to as a computer system. A person skilled in the art would understand that those terms may be used interchangeably. The components of FIG. 8 may be used to perform some or all operations and generate graphical user interfaces discussed in relation with FIGS. 1-7. Furthermore, various portions of the systems and methods described herein may include or be executed on one or more computer systems similar to computing system 800. Further, processes and modules described herein may be executed by one or more processing systems similar to that of computing system 800.

Computing system 800 may include one or more processors (e.g., processors 810a-810n) coupled to system memory 820, an input/output I/O device interface 830, and a network interface 840 via an input/output (I/O) interface 850. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 800. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 820). Computing system 800 may be a uni-processor system including one processor (e.g., processor 810a), or a multi-processor system including any number of suitable processors (e.g., 810a-810n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 800 may include a plurality of computing devices (e.g., distributed computer systems) to implement various processing functions.

I/O device interface 830 may provide an interface for connection of one or more I/O devices 860 to computer system 800. I/O devices may include devices that receive input (e.g., from a user) or output information (e.g., to a user). I/O devices 860 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 860 may be connected to computer system 800 through a wired or wireless connection. I/O devices 860 may be connected to computer system 800 from a remote location. I/O devices 860 located on remote computer systems, for example, may be connected to computer system 800 via a network using network interface 840.

Network interface 840 may include a network adapter that provides for connection of computer system 800 to a network. Network interface 840 may facilitate data exchange between computer system 800 and other devices connected to the network. Network interface 840 may support wired or wireless communication. The network may include an electronic communication network, such as the Internet, a local area network (LAN), a wide area network (WAN), a cellular communications network, or the like.

System memory 820 may be configured to store program instructions 870 or data 880. Program instructions 870 may be executable by a processor (e.g., one or more of processors 810a-810n) to implement one or more embodiments of the present techniques. Program instructions 870 may include modules of computer program instructions for implementing one or more techniques described herein with regard to various processing modules. Program instructions 870 may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 820 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 820 may include a non-transitory computer readable storage medium that may have program instructions stored thereon that are executable by a computer processor (e.g., one or more of processors 810a-810n) to cause the subject matter and the functional operations described herein. A memory (e.g., system memory 820) may include a single memory device and/or a plurality of memory devices (e.g., distributed memory devices).

I/O interface 850 may be configured to coordinate I/O traffic between processors 810a-810n, system memory 820, network interface 840, I/O devices 860, and/or other peripheral devices. I/O interface 850 may perform protocol, timing, or other data transformations to convert data signals from one component (e.g., system memory 820) into a format suitable for use by another component (e.g., processors 810a-810n). I/O interface 850 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 800, or multiple computer systems 800 configured to host different portions or instances of embodiments. Multiple computer systems 800 may provide for parallel or sequential processing/execution of one or more portions of the techniques described herein.

Those skilled in the art will appreciate that computer system 800 is merely illustrative and is not intended to limit the scope of the techniques described herein. Computer system 800 may include any combination of devices or software that may perform or otherwise provide for the performance of the techniques described herein. For example, computer system 800 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 800 may also be connected to other devices that are not illustrated or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

### Computing Operation Flow

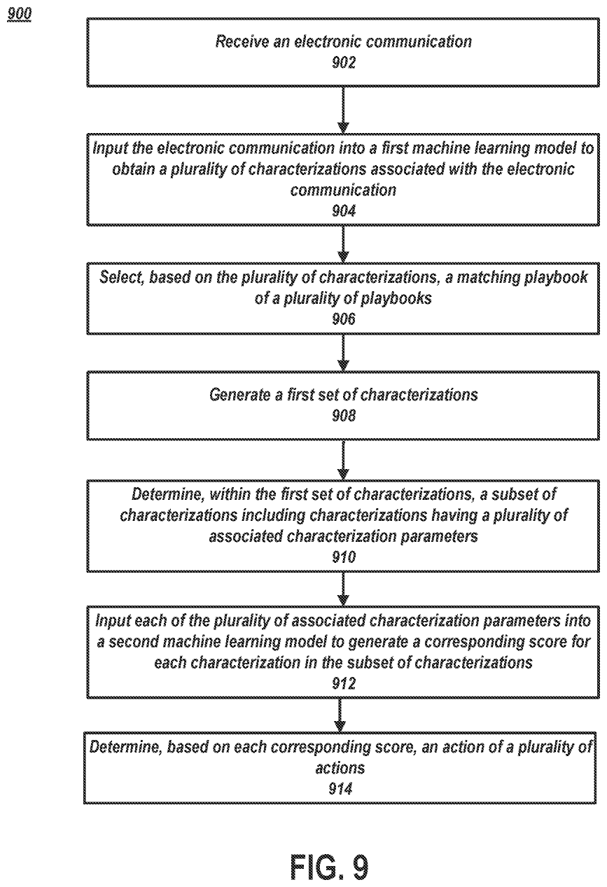

FIG. 9 illustrates a flowchart 900 of operations for a mechanism for identifying insights and themes in an electronic communication. The operations of FIG. 9 may use components described in relation to FIG. 8 and may be performed on machine learning models described in FIG. 4. At 902, communication processing system 102 receives an electronic communication. Communication processing system 102 may receive the electronic communication via network interface 840 from a network (e.g., network 150).

At 904, communication processing system 102 inputs the electronic communication into a first machine learning model to obtain a plurality of characterizations associated with the electronic communication. Communication processing system 102 may perform the input operation using an API. The first machine learning model may be hosted on communication processing system 102 or on data node 104. When the first machine learning model is hosted on data node 104, communication processing system 102 may use network interface 840 to perform the input operation over network 150.

At 906, communication processing system 102 select, based on the plurality of characterizations, a matching playbook of a plurality of playbooks. Communication processing system 102 may use one or more processors 810a-810n to perform the selection operation. At 908, communication processing system 102 generates a first set of characterizations. Communication processing system 102 may use one or more processors 810a-810n to perform the generation operation. The first set of characterizations may be stored in system memory 820 and or on data node 104 to be retrieved at a later time.

At 910, communication processing system 102 determines, within the first set of characterizations, a subset of characterizations including characterizations having a plurality of associated characterization parameters. For example, communication processing system 102 may make the determination using processors 810a-810n and store the subset of characterizations in system memory 820. At 912, communication processing system 102 inputs each of the plurality of associated characterization parameters into a second machine learning model to generate a corresponding score for each characterization in the subset of characterizations. Communication processing system 102 may perform the input operation using an API. The second machine learning model may be hosted on communication processing system 102 or on data node 104. When the second machine learning model is hosted on data node 104, communication processing system 102 may use network interface 840 to perform the input operation over network 150.

At 914, communication processing system 102 determines, based on each corresponding score, an action of a plurality of actions. For example, communication processing system 102 may make the determination using processors 810a-810n. In some embodiments, communication processing system 102 may execute the action using one or more components of FIG. 8. For example, to send an electronic message, communication processing system 102 may use network interface 840.

The techniques for identifying insights and themes in an electronic communication will be better understood with reference to the following enumerated embodiments:

1. A method comprising: receiving an electronic communication comprising a user interaction; inputting the electronic communication into a first machine learning model to obtain a plurality of characterizations associated with the electronic communication, wherein the first machine learning model has been trained to output one or more characterizations responsive to an input of electronic communication data; selecting, based on the plurality of characterizations, a matching playbook of a plurality of playbooks; generating a first set of characterizations, wherein the first set of characterizations comprises characterizations within the plurality of characterizations that match the characterizations within the matching playbook; determining, within the first set of characterizations, a subset of characterizations comprising those characterizations having a plurality of associated characterization parameters; inputting each of the plurality of associated characterization parameters into a second machine learning model to generate a corresponding score for each characterization in the subset of characterizations, wherein the second machine learning model is trained to generate scores based on characterization parameters; and determining, based on each corresponding score, an action of a plurality of actions.

2. Any of the proceeding embodiments, further comprising: receiving a plurality of electronic communications comprising user interactions; inputting each of the plurality of electronic communications into the first machine learning model to obtain the plurality of characterizations associated with the plurality of electronic communications; receiving, from an input device, a plurality of groupings for the plurality of characterizations; and generating the plurality of playbooks based on the plurality of groupings.

3. Any of the proceeding embodiments, further comprising: determining that a first characterization parameter of the subset of characterization parameters comprises timing data; and inputting, into the second machine learning model, the first characterization parameter and a parameter type associated with the timing data.

4. Any of the proceeding embodiments, further comprising: determining that a first characterization parameter of the subset of characterization parameters comprises question answer data; and inputting, into the second machine learning model, the first characterization parameter and a parameter type associated with the question answer data.

5. Any of the proceeding embodiments, further comprising: determining an associated score for each characterization that is within the first set of characterizations and not with the subset of characterizations; and determining the action of the plurality of actions based on each associated score.

6. Any of the proceeding embodiments, further comprising: receiving, from an input device, a plurality of phrases, for a new characterization; and training the first machine learning model using the plurality of phrases and the new characterization to recognize the new characterization as associated with the plurality of phrases.

7. Any of the proceeding embodiments, wherein inputting the electronic communication into the first machine learning model to obtain the plurality of characterizations associated with the electronic communication comprises: generating a transcription of the electronic communication; determining a type associated with the electronic communication; and retrieving a plurality of electronic communication parameters corresponding to the type associated with the electronic communication.

8. Any of the proceeding embodiments, wherein the plurality of electronic communication parameters comprises one or more of communication duration, communication sentiment, silence duration within the electronic communication, and simultaneous speech duration within the electronic communication.

9. A tangible, non-transitory, machine-readable medium storing instructions that, when executed by a data processing apparatus, cause the data processing apparatus to perform operations comprising those of any of embodiments 1-8.

10. A system comprising: one or more processors; and memory storing instructions that, when executed by the processors, cause the processors to effectuate operations comprising those of any of embodiments 1-8.

11. A system comprising means for performing any of embodiments 1-8.

12. A system comprising cloud-based circuitry for performing any of embodiments 1-8.

Although the present invention has been described in detail for the purpose of illustration based on what is currently considered to be the most practical and preferred embodiments, it is to be understood that such detail is solely for that purpose, and that the invention is not limited to the disclosed embodiments, but on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration, and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

What is claimed is:

1. A system for generating playbooks, the system comprising:
one or more processors; and
a non-transitory computer-readable storage medium storing instructions, which when executed by the one or more processors cause the one or more processors to:
receive a plurality of electronic communications comprising user interactions;
input each of the plurality of electronic communications into a first machine learning model to obtain a plurality of characterizations associated with the plurality of electronic communications, wherein the first machine learning model has been trained to output one or more characterizations responsive to an input of electronic communication data;
receive, from an input device, a plurality of groupings for the plurality of characterizations, wherein each grouping of the plurality of groupings corresponds to a playbook;
generate a plurality of playbooks based on the plurality of groupings;
receive an electronic communication comprising a user interaction;
input the electronic communication into the first machine learning model to obtain a set of characterizations associated with the electronic communication;
compare, the set of characterizations to characterizations within each of the plurality of playbooks;
select, based on the comparing, a matching playbook of the plurality of playbooks;
generate a matching set of characterizations, wherein the matching set of characterizations comprises those characterizations within the plurality of characterizations that match the characterizations within the matching playbook;
determine, within the matching set of characterizations, a subset of characterizations comprising characterizations having a plurality of associated characterization parameters;
input each of the plurality of associated characterization parameters into a second machine learning model to generate a corresponding score for each characterization in the subset of characterizations, wherein the second machine learning model is trained to generate scores based on characterization parameters; and
determine, based on each corresponding score, an action of a plurality of actions.

2. The system of claim 1, wherein the instructions, when executed by the one or more processors, further cause the one or more processors to:
determine that a first characterization parameter of the subset of characterization parameters comprises timing data; and
input, into the second machine learning model, the first characterization parameter and a parameter type associated with the timing data.

3. The system of claim 1, wherein the instructions, when executed by the one or more processors, further cause the one or more processors to:
determine that a first characterization parameter of the subset of characterization parameters comprises string data; and
input, into the second machine learning model, the first characterization parameter and a parameter type associated with the string data.

4. The system of claim 1, wherein the instructions, when executed by the one or more processors, further cause the one or more processors to:
determine an associated score for each characterization that is within the matching set of characterizations and not with the subset of characterizations; and
determine the action of the plurality of actions based on each associated score.

5. A method comprising:
receiving an electronic communication comprising a user interaction;
inputting the electronic communication into a first machine learning model to obtain a plurality of characterizations associated with the electronic communication, wherein the first machine learning model has been trained to output one or more characterizations responsive to an input of electronic communication data;
selecting, based on the plurality of characterizations, a matching playbook of a plurality of playbooks;
generating a first set of characterizations, wherein the first set of characterizations comprises characterizations within the plurality of characterizations that match the characterizations within the matching playbook;
determining, within the first set of characterizations, a subset of characterizations comprising those characterizations having a plurality of associated characterization parameters;
inputting each of the plurality of associated characterization parameters into a second machine learning model to generate a corresponding score for each characterization in the subset of characterizations, wherein the second machine learning model is trained to generate scores based on characterization parameters; and
determining, based on each corresponding score, an action of a plurality of actions.

6. The method of claim 5, further comprising:
receiving a plurality of electronic communications comprising user interactions;
inputting each of the plurality of electronic communications into the first machine learning model to obtain the plurality of characterizations associated with the plurality of electronic communications;
receiving, from an input device, a plurality of groupings for the plurality of characterizations; and
generating the plurality of playbooks based on the plurality of groupings.

7. The method of claim 5, further comprising:
determining that a first characterization parameter of the subset of characterization parameters comprises timing data; and
inputting, into the second machine learning model, the first characterization parameter and a parameter type associated with the timing data.

8. The method of claim 5, further comprising:
determining that a first characterization parameter of the subset of characterization parameters comprises question answer data; and
inputting, into the second machine learning model, the first characterization parameter and a parameter type associated with the question answer data.

9. The method of claim 5, further comprising:
determining an associated score for each characterization that is within the first set of characterizations and not with the subset of characterizations; and
determining the action of the plurality of actions based on each associated score.

10. The method of claim 5, further comprising:
receiving, from an input device, a plurality of phrases, for a new characterization; and
training the first machine learning model using the plurality of phrases and the new characterization to recognize the new characterization as associated with the plurality of phrases.

11. The method of claim 5, wherein inputting the electronic communication into the first machine learning model to obtain the plurality of characterizations associated with the electronic communication comprises:
generating a transcription of the electronic communication;
determining a type associated with the electronic communication; and
retrieving a plurality of electronic communication parameters corresponding to the type associated with the electronic communication.

12. The method of claim 11, wherein the plurality of electronic communication parameters comprises one or more of communication duration, communication sentiment, silence duration within the electronic communication, and simultaneous speech duration within the electronic communication.

13. A non-transitory, computer-readable medium storing instructions for processing electronic communications, the instructions when executed by one or more processors, cause the one or more processors to perform operations comprising:
receiving an electronic communication comprising a user interaction;
inputting the electronic communication into a first machine learning model to obtain a plurality of characterizations associated with the electronic communication, wherein the first machine learning model has been trained to output one or more characterizations responsive to an input of electronic communication data;
selecting, based on the plurality of characterizations, a matching playbook of a plurality of playbooks;
generating a first set of characterizations, wherein the first set of characterizations comprises characterizations within the plurality of characterizations that match the characterizations within the matching playbook;
determining, within the first set of characterizations, a subset of characterizations comprising characterizations having a plurality of associated characterization parameters;
inputting each of the plurality of associated characterization parameters into a second machine learning model to generate a corresponding score for each characterization in the subset of characterizations, wherein the second machine learning model is trained to generate scores based on characterization parameters; and
determining, based on each corresponding score, an action of a plurality of actions.

14. The non-transitory, computer-readable medium of claim 13, wherein the instructions further cause the one or more processors to perform operations comprising:
receiving a plurality of electronic communications comprising user interactions;
inputting each of the plurality of electronic communications into the first machine learning model to obtain a plurality of characterizations associated with the plurality of electronic communications;
receiving, from an input device, a plurality of groupings for the plurality of characterizations; and
generating a plurality of playbooks based on the plurality of groupings.

15. The non-transitory, computer-readable medium of claim 14, wherein the instructions further cause the one or more processors to perform operations comprising:
determining that a first characterization parameter of the subset of characterization parameters comprises timing data; and
inputting, into the second machine learning model, the first characterization parameter and a parameter type associated with the timing data.

16. The non-transitory, computer-readable medium of claim 13, wherein the instructions further cause the one or more processors to perform operations comprising:
determining that a first characterization parameter of the subset of characterization parameters comprises question answer data; and
inputting, into the second machine learning model, the first characterization parameter and a parameter type associated with the question answer data.

17. The non-transitory, computer-readable medium of claim 13, wherein the instructions further cause the one or more processors to perform operations comprising:
determining an associated score for each characterization that is within the first set of characterizations and not with the subset of characterizations; and
determining the action of the plurality of actions based on each associated score.

18. The non-transitory, computer-readable medium of claim 13, wherein the instructions further cause the one or more processors to perform operations comprising:
receiving, from an input device, a plurality of phrases, for a new characterization; and
training the first machine learning model using the plurality of phrases and the new characterization to recognize the new characterization as associated with the plurality of phrases.

19. The non-transitory, computer-readable medium of claim 18, wherein the instructions for inputting the electronic communication into the first machine learning model to obtain the plurality of characterizations associated with the electronic communication further cause the one or more processors to perform operations comprising:
generating a transcription of the electronic communication;
determining a type associated with the electronic communication; and
retrieving a plurality of electronic communication parameters corresponding to the type associated with the electronic communication.

20. The non-transitory, computer-readable medium of claim 19, wherein the plurality of electronic communication parameters comprises one or more of communication duration, communication sentiment, silence duration within the electronic communication, and simultaneous speech duration within the electronic communication.
